(19) United States
(12) Patent Application Publication
(10) Pub. No.: US 2024/0216858 A1
(43) Pub. Date: Jul. 4, 2024

(54) AIR PURIFIER

(71) Applicant: Samsung Electronics Co., Ltd., Suwon-si (KR)

(72) Inventors: Jaiyoung CHUNG, Suwon-si (KR); Dongwook KIM, Suwon-si (KR); Joonseon JEONG, Suwon-si (KR); Jinkyu KANG, Suwon-si (KR); Dongjin LEE, Suwon-si (KR); Jaehee CHANG, Suwon-si (KR)

(21) Appl. No.: 18/212,544

(22) Filed: Jun. 21, 2023

(30) Foreign Application Priority Data
Dec. 29, 2022 (KR) 10-2022-0189815

(51) Int. Cl. B01D 53/32; B01D 45/08; B01D 47/06; B01D 50/40; B03C 3/01; B03C 3/08; B03C 3/09; B03C 3/47; B03C 3/49

(52) U.S. Cl. CPC B01D 53/323; B01D 45/08; B01D 47/06; B01D 50/40; B03C 3/01; B03C 3/08; B03C 3/09; B03C 3/47; B03C 3/49; B01D 2259/818

(57) ABSTRACT

An air purifier includes an air inlet through which contaminated air is introduced, a plasma reaction unit connected in fluid communication with the air inlet and including a predetermined discharge region generating discharge plasma, and a dust collector that is connected in fluid communication with the plasma reaction unit and collects and removes contaminants from first purified air discharged from the plasma reaction unit.

This application claims priority to Korean Patent Application No. 10-2022-0189815, filed on Dec. 29, 2022, and all the benefits accruing therefrom under 35 U.S.C. § 119, the content of which in its entirety is herein incorporated by reference.

### BACKGROUND

### 1. Field

The disclosure relates to an air purifier for purifying fine dust and contaminants in a gas.

### 2. Description of the Related Art

An air purifier purifies air by collecting or decomposing fine dust and contaminants in gases such as air. An air purifier may be applied to industrial dust collection facilities, air conditioning/ventilation systems in buildings, and the like.

As representative methods for removing fine dust and contaminants in air, there are adsorption methods and dust collection methods. The adsorption method collects fine dust and contaminants included in air by an adsorbent having a large surface area. Also, a dust collection method purifies air by charging fine dust and contaminants included in the air and collects the charged fine dust and contaminants on a dust collection plate by electrostatic force. The dust collection method and adsorption method have excellent efficiency in removal of fine dust and pollutants, and may filter various types of fine dust and pollutants from the air. In addition, an air purification method in which contaminants are decomposed and removed using discharge plasma may be used.

### SUMMARY

Provided is an air purifier capable of removing fine dust and contaminants through discharge plasma, dust collector, gas-liquid mixing, and gas-liquid contact.

Provided is an air purifier capable of removing pollutants of various sizes and various types of pollutants.

Provided is an air purifier with improved performance in removing fine dust and contaminants.

Additional features will be set forth in part in the description which follows and, in part, will be apparent from the description, or may be learned by practice of the presented embodiments of the disclosure.

In an embodiment of the disclosure, an air purifier includes an air inlet through which contaminated air is introduced, a plasma reaction unit connected in fluid communication with the air inlet and including a predetermined discharge region generating discharge plasma, and a dust collector connected in fluid communication with the plasma reaction unit to collect and remove contaminants from first purified air discharged from the plasma reaction unit.

In an embodiment, the plasma reaction unit may include a reactor having a hollow shape and mainly extending in one direction, a 1-1 electrode disposed inside the reactor, a 1-2 electrode disposed to be spaced apart from the 1-1 electrode with a predetermined gap therebetween, and a first power supply source which applies a predetermined voltage to the 1-1 electrode and the 1-2 electrode. The reactor may include at least one cross section of a circular or polygonal shape.

In an embodiment, the plasma reaction unit may be provided in plural, and a plurality of reactors included the plurality of plasma reaction units, respectively, may be arranged to be adjacent to each other.

In an embodiment, the air purifier may further include a coolant passage disposed between the plurality of reactors respectively included in the plurality of plasma reaction units, and a coolant moving along the coolant passage.

In an embodiment, the dust collector may include a 2-1 electrode having a plate shape extending along one plane, a 2-2 electrode disposed to face the 2-1 electrode and having a plate shape extending along the one plane, and a second power supply source which applies a predetermined voltage to the 2-1 electrode and the 2-2 electrode.

In an embodiment, the 2-1 electrode and the 2-2 electrode may be porous plates including predetermined pores. The first purified air may move to pass through the 2-1 electrode and the 2-2 electrode.

In an embodiment, the 2-1 electrode and the 2-2 electrode may include one or more of porous nickel foam, aluminum foam, copper foam, stainless steel foam, or iron foam, titanium foam, silver foam, carbon foam, and graphene foam.

In an embodiment, the dust collector may include a 2-1 electrode having a plate shape extending along one plane, a 2-2 electrode disposed to face the 2-1 electrode and having a needle shape including a predetermined cross-sectional area, a plurality of dielectric particles disposed between the 2-1 electrode and the 2-2 electrode, and a second power supply source which applies a predetermined voltage to the 2-1 electrode and the 2-2 electrode.

In an embodiment, the plurality of dielectric particles may include a metal oxide, metal nitride, or polymer, e.g., at least one of silicon oxide, boron oxide, aluminum oxide, manganese oxide, titanium oxide, barium oxide, copper oxide, magnesium oxide, zinc oxide, zirconium oxide, yttrium oxide, calcium oxide, nickel oxide, iron oxide, polytetrafluoroethylene (“PTFE”), and rubber, or one or more of combinations of the above materials.

In an embodiment, the dust collector may include a 2-1 electrode having a rod shape mainly extending in one direction, a 2-2 electrode disposed to face the 2-1 electrode and having a plate shape extending along a plane, and a second power supply source which applies a predetermined voltage to the 2-1 electrode and the 2-2 electrode.

In an embodiment, the 2-1 electrode may be provided in plural, and a plurality of 2-1 electrodes may be disposed to face the 2-2 electrode and be spaced apart from each other with a predetermined gap therebetween.

In an embodiment, the 2-2 electrode is a porous plate including predetermined pores. The first purified air may move to pass through the 2-2 electrode.

In an embodiment, the dust collector may include a 2-1 electrode having a plate shape extending along one plane, a 2-2 electrode disposed to face the 2-1 electrode, having a plate shape extending along the one plane, and being grounded, and a second power supply source which applies a predetermined voltage to the 2-1 electrode and the 2-2 electrode. The first purified air may move along between the 2-1 electrode and the 2-2 electrode.

In an embodiment, the dust collector may include a 2-1 electrode having a plate shape extending along one plane, a 2-2 electrode disposed to face the 2-1 electrode and having a plate shape extending along the one plane, a second power supply source which applies a predetermined voltage to the 2-1 electrode and the 2-2 electrode; and a dust collecting plate disposed at a rear end of the 2-1 electrode and the 2-2 electrode along a movement direction of the first purified air. The first purified air moves between the 2-1 electrode and the 2-2 electrode.

In an embodiment, the dust collecting plate may be a porous plate including predetermined pores. The first purified air may move to pass through the dust collecting plate.

In an embodiment, the dust collector may include a 2-1 electrode having a rod shape mainly extending in the one direction, a 2-2 electrode which has a cylindrical shape mainly extending in the one direction and is grounded, and in which the 2-1 electrode is arranged, and a second power supply source which applies a predetermined voltage to the 2-1 electrode and the 2-2 electrode. The first purified air may move along between the 2-1 electrode and the 2-2 electrode.

In an embodiment, the dust collector may include a 2-1 electrode having a rod shape mainly extending in the one direction, a 2-2 electrode having a cylindrical shape mainly extending in the one direction and having the 2-1 electrode arranged therein, a second power supply source which applies a predetermined voltage to the 2-1 electrode and the 2-2 electrode; and a dust collecting plate disposed at a rear end of the 2-1 electrode and the 2-2 electrode along a movement direction of the first purified air. The first purified air may move between the 2-1 electrode and the 2-2 electrode.

In an embodiment, the dust collecting plate may be a porous plate including predetermined pores. The first purified air may move to pass through the dust collecting plate.

In another embodiment of the disclosure, an air purifier includes an air inlet through which contaminated air is introduced; a plasma reaction unit connected in fluid communication with the air inlet and including a predetermined discharge region generating discharge plasma; a gas-liquid mixing unit connected in fluid communication with the plasma reaction unit, and including a gas-liquid mixing unit housing, a droplet ejection device disposed in the gas-liquid mixing unit housing and including one or more ejection nozzles ejecting fine droplets and a fluid mixing device that mixes the fine droplets and first purified air transferred from the plasma reaction unit; a gas-liquid contact unit connected in fluid communication with the gas-liquid mixing unit, forming a micro-channel through which a gas-liquid mixed fluid transferred from the gas-liquid mixing unit passes, and including an impactor collecting droplets included in the gas-liquid mixed fluid; and a dust collector connected in fluid communication with the gas-liquid contact unit and collecting and removing contaminants from a fourth purified air discharged from the gas-liquid contact unit.

In an embodiment, the impactor may include an inclined surface having a predetermined inclination angle with respect to a direction of gravity.

### BRIEF DESCRIPTION OF THE DRAWINGS

The above and other features and advantages of illustrative embodiments of the disclosure will be more apparent from the following description taken in conjunction with the accompanying drawings, in which:

FIG. 1 is a block diagram of an embodiment of an air purifier;

FIG. 2 is a schematic diagram of an embodiment of a configuration of an air purifier;

FIG. 3 is an enlarged cross-sectional view of an embodiment of a part of a plasma reaction unit shown in FIG. 2;

FIGS. 4A to 4D are cross-sectional views schematically illustrating a cross-sectional view of an embodiment of a plasma reaction unit;

FIG. 5A is a perspective view of an embodiment of a plurality of reactors;

FIG. 5B is a cross-sectional view of an embodiment of a plurality of plasma reaction units;

FIG. 6A is a perspective view of an embodiment of a plurality of reactors;

FIG. 6B is a cross-sectional view of an embodiment of a plurality of plasma reaction units;

FIG. 7A is a schematic perspective view of an embodiment of a dust collector;

FIG. 7B is a schematic side view of an embodiment of a dust collector;

FIG. 8A is a schematic perspective view of an embodiment of a dust collector;

FIG. 8B is a schematic side view of an embodiment of a dust collector;

FIG. 9A is a schematic perspective view of an embodiment of a dust collector;

FIG. 9B is a schematic side view of an embodiment of a dust collector;

FIG. 10 is a schematic perspective view of an embodiment of a dust collector;

FIG. 11A is a schematic perspective view of an embodiment of a dust collector;

FIG. 11B is a schematic side view of an embodiment of a dust collector;

FIG. 11C is a schematic perspective view of an embodiment of a dust collector;

FIG. 11D is a schematic side view of an embodiment of a dust collector;

FIG. 12A is a schematic perspective view of an embodiment of a dust collector;

FIG. 12B is a schematic perspective view of an embodiment of a dust collector;

FIG. 13 is a block diagram of an embodiment of an air purifier;

FIG. 14 is a schematic diagram of an embodiment of a configuration of an air purifier;

FIG. 15 is a perspective view of an embodiment of an impactor; and

FIGS. 16A and 16B are schematic perspective views of an embodiment of an impactor.

### DETAILED DESCRIPTION

Reference will now be made in detail to embodiments, illustrative embodiments of which are illustrated in the accompanying drawings, where like reference numerals refer to like elements throughout. In this regard, the illustrated embodiments may have different forms and should not be construed as being limited to the descriptions set forth herein. Accordingly, the embodiments are merely described below, by referring to the drawing figures, to explain features. As used herein, the term “and/or” includes any and all combinations of one or more of the associated listed items. Expressions such as “at least one of,” when preceding a list of elements, modify the entire list of elements and do not modify the individual elements of the list.

Reference will now be made in detail to embodiments, illustrative embodiments of which are illustrated in the accompanying drawings. In the drawings, like reference numerals refer to like elements throughout, and sizes of elements in the drawings may be exaggerated for clarity and convenience of explanation.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). The term such as “about” can mean within one or more standard deviations, or within +30%, 20%, 10%, 5% of the stated value, for example.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

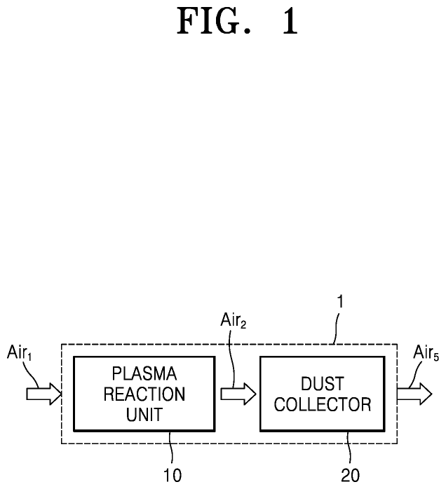

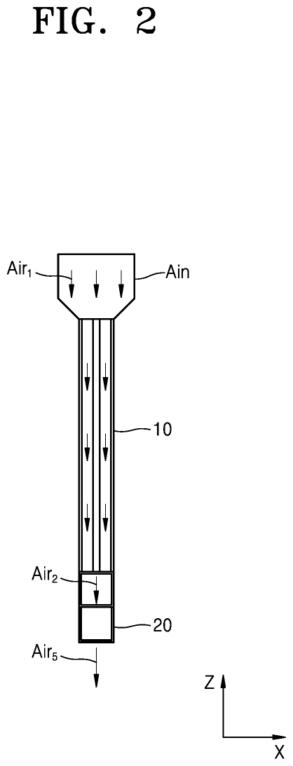

FIG. 1 is a block diagram of an embodiment of an air purifier 1. FIG. 2 is a schematic diagram of an embodiment of a configuration of the air purifier 1.

Referring to FIGS. 1 and 2, the air purifier 1 in an embodiment may include an air inlet Aᵢₙ through which contaminated air Air₁ is introduced, a plasma reaction unit 10 connected in fluid communication with the air inlet Aᵢₙ and purifying polluted air using discharge plasma, and a dust collector 20 that is connected in fluid communication with the plasma reaction unit 10 and removes contaminants from first purified air Air₂ discharged from the plasma reaction unit 10 by collecting the contaminants.

The plasma reaction unit 10 and the dust collector 20 in an embodiment may be sequentially disposed along a flow direction of the contaminated air Air₁. Accordingly, the first purified air Air₂ discharged from the plasma reaction unit 10 may flow into the dust collector 20 in a charged state by the discharge plasma.

In the specification, contaminated air Air₁ refers to a mixed gas including air and at least one of fine dust, water-soluble organic compound, and non-water-soluble organic compound. In an embodiment, fine dust may include relatively small fine dust of about 10 micrometer (μm) or less and ultra-fine dust of about 0.3 μm or less. In addition, the water-soluble organic compound is a volatile organic compound and may include gaseous substances that may be collected and removed in water or an aqueous solution, such as ammonia (NH₃), acetaldehyde (CH₃CHO), and acetic acid (CH₃COOH). In addition, the water-insoluble organic compound is a volatile organic compound that is not collected in water or an aqueous solution, and may include, e.g., benzene (C₆H₆), formaldehyde (CH₂O), toluene (C₆H₅CH₃), or the like. However, the disclosure is not limited thereto, and arbitrary gases other than fine dust, water-soluble organic compounds, and non-water-soluble organic compounds may be included in the contaminated air Air₁. Hereinafter, each of the plasma reaction unit 10 and the dust collector 20 through which the contaminated air Air₁ passes will be described in more detail. A fifth purified air Air₅ may be discharged from the air purifier 1. The fifth purified air Air₅ will be further described below.

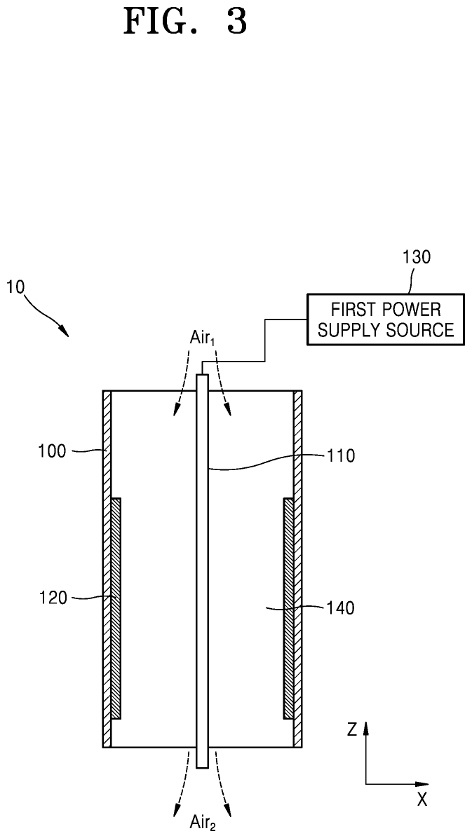

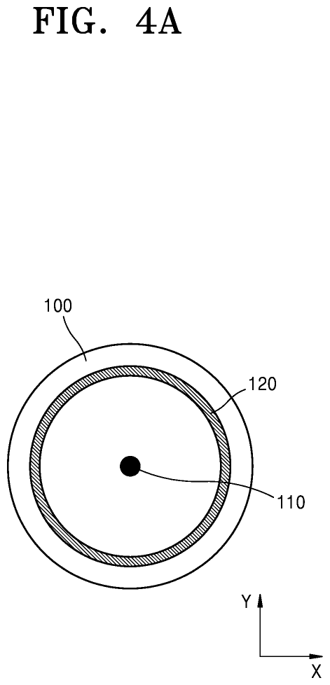

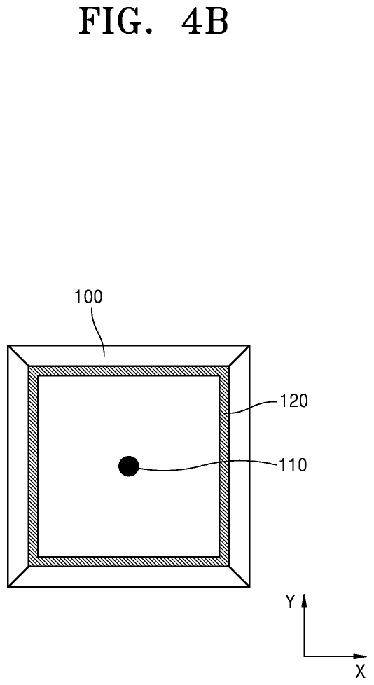

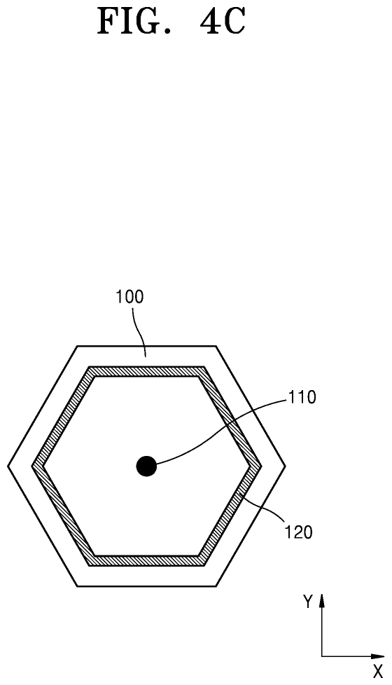

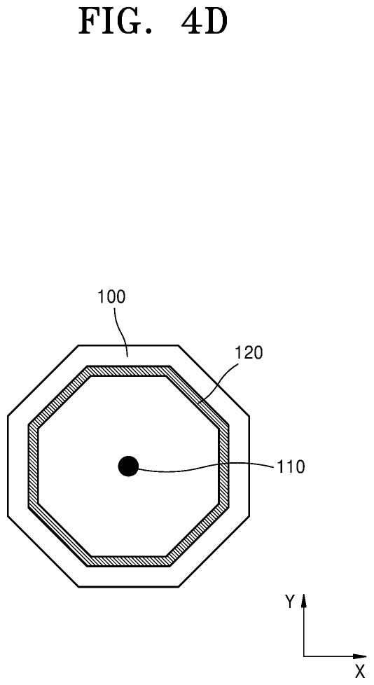

FIG. 3 is an enlarged cross-sectional view of a part of the plasma reaction unit 10 shown in FIG. 2. FIGS. 4A to 4D are cross-sectional views schematically illustrating a cross-sectional view of an embodiment of the plasma reaction unit 10.

The plasma reaction unit 10 included in the air purifier 1 in an embodiment may include at least one discharge method among a dielectric barrier discharge, a corona discharge, an arc discharge, a microwave induced discharge and a radio frequency discharge. However, the disclosure is not limited thereto, and a plasma reaction unit 10 according to any plasma discharge method may be used.

Referring to FIGS. 2 and 3, the plasma reaction unit 10 in an embodiment includes a reactor 100 having a hollow shape and mainly extending in one direction (vertical direction in FIG. 3), a 1-1 electrode 110 disposed inside the reactor 100, a 1-2 electrode 120 disposed to be spaced apart from the 1-1 electrode 110 with a predetermined gap therebetween, and a first power supply source 130 which applies a predetermined voltage to the 1-1 electrode 110 and the 1-2 electrode 120.

The reactor 100 may extend in one direction and may have a hollow shape through which contaminated air Air₁ and liquid may flow. In an embodiment, the reactor 100 may be provided with a glass conduit or an aluminum conduit extending in one direction.

The reactor 100 in an embodiment may be provided as a hollow conduit having at least one cross section of a circular shape or a polygonal shape. In an embodiment, as shown in FIG. 4A, the reactor 100 may be provided in a circular conduit shape including a circular cross section. Also, as shown in FIG. 4B, the reactor 100 may be provided in a conduit shape having a quadrangular cross section, e.g., rectangular cross section. Also, as shown in FIG. 4C, the reactor 100 may be provided in a conduit shape having a hexagonal cross section. Also, as shown in FIG. 4D, the reactor 100 may be provided in a conduit shape having an octagonal cross section.

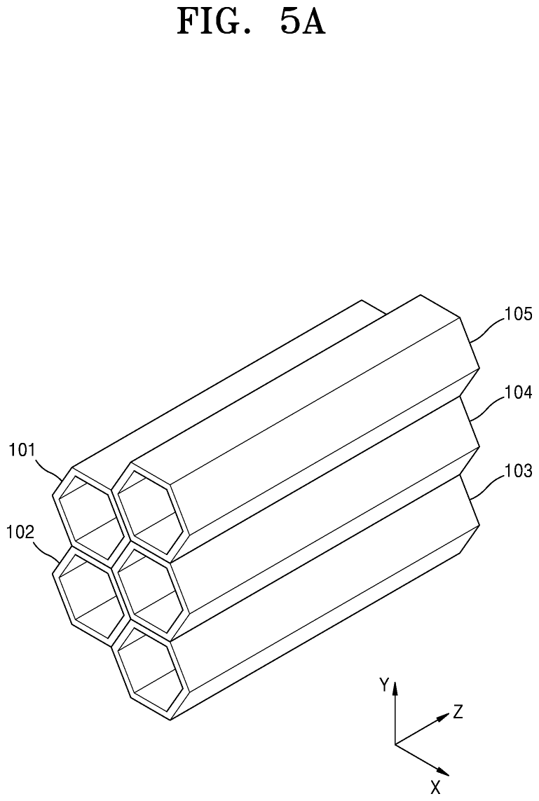

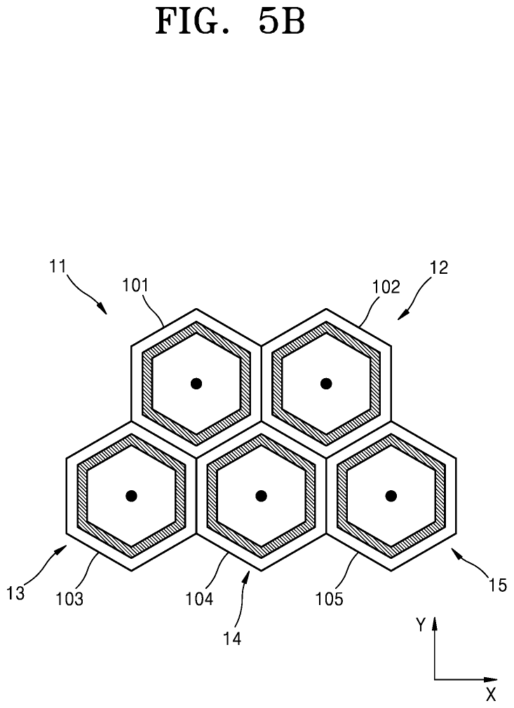

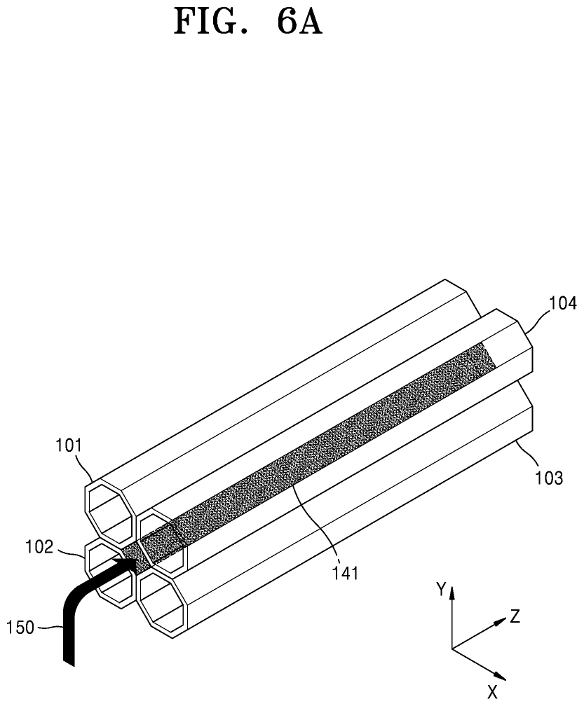

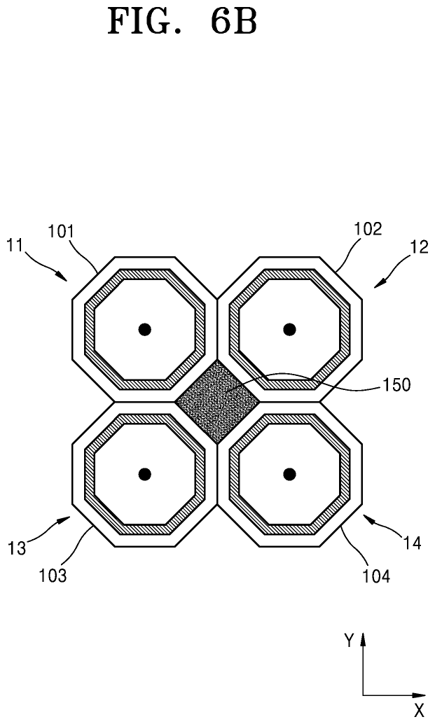

In an embodiment, since the reactor 100 includes at least one cross section of a circular shape or a polygonal shape, a plurality of reactors 100 may be integrated and disposed adjacent to each other. Accordingly, a cross-sectional area of the reactor 100 through which the contaminated air Air₁ passes may be increased, and an entirety of the air purifier 1 may be downsized. Descriptions related to integrating and arranging the plurality of reactors 100 adjacent to each other will be given later with reference to FIGS. 5A to 6D.

The 1-1 electrode 110 may extend in one direction and may be disposed inside the reactor 100. In an embodiment, the 1-1 electrode 110 is a power electrode and may be connected to the first power supply source 130. In an embodiment, the 1-1 electrode 110 may be provided as a steel wire mainly extending in one direction and disposed inside the reactor 100. However, the disclosure is not limited thereto, and the 1-1 electrode 110 may be provided in an arbitrary electrode structure form extending in one direction.

The 1-2 electrode 120 may be spaced apart from the 1-1 electrode 110 with a predetermined distance therebetween. In an embodiment, a discharge region 140 in which discharge plasma may be generated may be defined between the 1-1 electrode 110 and the 1-2 electrode 120. In an embodiment, the 1-2 electrode 120 may be a ground electrode disposed on an inner surface of the reactor 100. At this time, the discharge region 140 in which discharge plasma may be generated may be surrounded by the 1-2 electrode 120. In an embodiment, the 1-2 electrode 120 may be integrated with the reactor 100 when the reactor 100 is a conductor, and when the reactor 100 is a non-conductor, the 1-2 electrode 120 may be provided with a silver paste film and may be arranged to surround the inner wall of the reactor 100, for example.

Also, the first power supply source 130 may apply a relatively high voltage to the discharge region 140 where discharge plasma may be generated. The first power supply source 130 in an embodiment may include a sine wave alternating current (“AC”) power supply device and a transformer. The first power supply source 130 may continuously apply a relatively high voltage to the inside of the reactor 100, e.g., to the discharge region 140 where discharge plasma may be generated through the electrical system described above. In an embodiment, the voltage applied to the discharge region 140 may be about 1 kilovolt (kV) or more and about 100 kV or less, and a frequency may be about 10 hertz (Hz) or more and about 100 Hz or less, but the disclosure is not limited thereto. In addition, the separation distance between the 1-1 electrode 110 and the 1-2 electrode 120 in the discharge region 140 may be about 10 millimeters (mm) or more and about 100 mm or less, and accordingly, an electric field of about 1 kilovolt per centimeter (kV/cm) or more and about 10 kV/cm or less may be applied to the discharge region 140.

In an embodiment, a water-soluble organic compound may be directly decomposed using the plasma reaction unit 10. In an embodiment, when a relatively high voltage is applied to the discharge region 140, the water-soluble organic compound may be decomposed using OH radicals (OH·). In an embodiment, when a relatively high voltage is applied to the discharge region 140, oxygen (O₂) and water molecules (H₂O) in the air around the 1-1 electrode 110 disposed inside the reactor 100 are broken and become a neutral gas ion state (plasma state), and thus, OH radicals (OH) may be generated from ions. In an embodiment, acetic acid (CH₃COOH), acetaldehyde (CH₃CHO), and methane (CH₄) among water-soluble organic compounds may be decomposed into carbon dioxide (CO₂) and water (H₂O) as shown in Reactions 1 to 3 below. At this time, carbon dioxide (CO₂) and water (H₂O), which are decomposed products, may be discharged to the outside of the reactor 100.

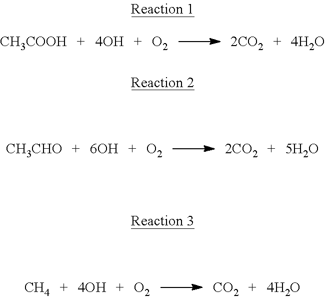

Also, in an embodiment, a non-water-soluble organic compound may be directly decomposed using the plasma reaction unit 10. In an embodiment, when a relatively high voltage is applied to the discharge region 140, the water-insoluble organic compound may be decomposed using OH radicals (OH·). In an embodiment, when a relatively high voltage is applied to the discharge region 140, oxygen (O₂) and water molecules (H₂O) in the air around the 1-1 electrode 110 disposed inside the reactor 100 are broken and become a neutral gas ion state (plasma state), and OH radicals (OH·) may be generated from these ions. In an embodiment, water-soluble organic toluene (C₆H₅CH₃) may be decomposed into carbon dioxide (CO₂) and water (H₂O) by an OH radical (OH·). At this time, carbon dioxide (CO₂) and water (H₂O), which are decomposed products, may be discharged to the outside of the reactor 100.

Also, in an embodiment, ozone (O₃) may be generated from oxygen (O₂) in the air by the plasma reaction unit 10. When ozone (O₃) is generated inside the reactor 100, the ozone (O₃) may be combined with fine droplets and used as ozonated water. However, when the concentration of ozone (O₃) generated by the plasma reaction unit 10 exceeds a range that may be used as ozone water, excess ozone (O₃) may also be removed by disposing an ozone decomposition catalyst filter (not shown) at a rear end of the plasma reaction unit 10.

As described above, by the decomposition method using the plasma reaction unit 10, water-soluble organic compounds and non-water-soluble organic compounds included in the contaminated air Air₁ passing through the reactor 100 may be removed. In addition, fine dust included in the contaminated air Air₁ passing through the reactor 100 may be charged by the discharge plasma. Accordingly, some contaminants may be removed by the plasma reaction unit 10 and the first purified air Air₂ including charged fine dust may be discharged from the plasma reaction unit 10.

FIG. 5A is a perspective view of an embodiment of a plurality of reactors. FIG. 5B is a cross-sectional view of an embodiment of a plurality of plasma reaction units. FIG. 6A is a perspective view of an embodiment of a plurality of reactors. FIG. 6B is a cross-sectional view of an embodiment of a plurality of plasma reaction units.

Referring to FIGS. 5A and 5B, a plurality of plasma reaction units 10 in an embodiment may be provided. In an embodiment, the plurality of plasma reaction units 10 may include five plasma reaction units. In an embodiment, the plurality of plasma reaction units 10 may include a first plasma reaction unit 11 to a fifth plasma reaction unit 15, for example. However, the disclosure is not limited thereto, and the number of plasma reaction units may be adjusted to an arbitrary number of two or more. Each of the plurality of plasma reaction units 10 in an embodiment may include a reactor 100. In an embodiment, first plasma reaction unit 11 to the fifth plasma reaction unit 15 may respectively include a first reactor 101 to a fifth reactor 105, for example.

The first reactor 101 to the fifth reactor 105 in an embodiment may include one or more cross sections of a circular shape or a polygonal shape. In an embodiment, the first reactor 101 to the fifth reactor 105 may be provided in a conduit shape having a hexagonal cross section, for example. Because the first reactor 101 to the fifth reactor 105 have a hexagonal cross section, the first reactor 101 to the fifth reactor 105 may be stacked adjacent to each other. Accordingly, the cross-sectional area of the reactor 100 through which the contaminated air Air₁ passes may be increased to a total cross-sectional area of the first reactor 101 to the fifth reactor 105. Accordingly, a treatment capacity for treating the contaminated air Air₁ may be increased. In addition, as the first reactor 101 to the fifth reactor 105 are stacked adjacent to each other, a space occupied by the air purifier 1 may be minimized.

Referring to FIGS. 6A and 6B, a plurality of plasma reaction units 10 in an embodiment may be provided. In an embodiment, the plurality of plasma reaction units 10 may include four plasma reaction units. In an embodiment, the plurality of plasma reaction units 10 may include a first plasma reaction unit 11 to a fourth plasma reaction unit 14, for example. Each of the plurality of plasma reaction units 10 in an embodiment may include a reactor 100. In an embodiment, the first plasma reaction unit 11 to the fourth plasma reaction unit 14 may respectively include a first reactor 101 to a fourth reactor 104, for example.

The first reactor 101 to the fourth reactor 104 in an embodiment may include one or more cross sections of a circular shape or a polygonal shape. In an embodiment, the first reactor 101 to the fourth reactor 104 may be provided in a conduit shape having an octagonal cross section, for example. Because the first reactor 101 to the fourth reactor 104 have an octagonal cross section, the first reactor 101 to the fourth reactor 104 may be stacked adjacent to each other.

In an embodiment, a predetermined separation space may be defined between the first reactor 101 to the fourth reactor 104. A coolant passage 141 may be formed in a predetermined separation space defined between the first reactor 101 to the fourth reactor 104. The coolant passage 141 may extend in one direction in which the first reactor 101 to the fourth reactor 104 extend. A predetermined coolant 150 may move in one direction in the coolant passage 141. In an embodiment, the coolant 150 may be any fluid material capable of absorbing heat generated in the first reactor 101 to the fourth reactor 104, such as water. The coolant passage 141 is disposed between the plurality of reactors 101 to 104, and as the coolant 150 moves along the coolant passage 141, heat generated in the process of forming the discharge plasma may be released to the outside. Accordingly, the treatment efficiency of the air purifier 1 may be increased.

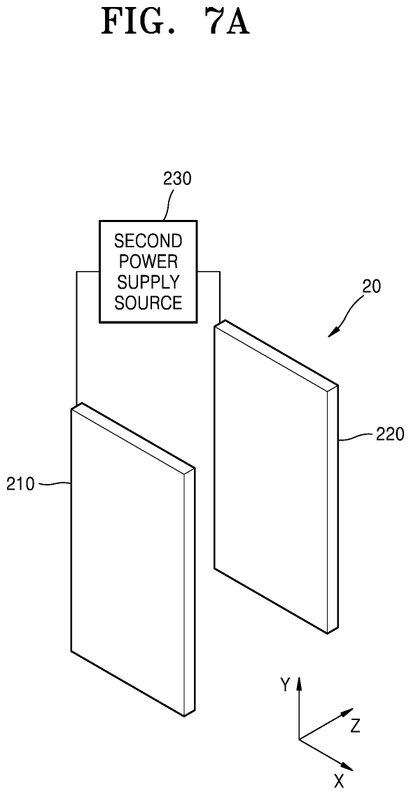

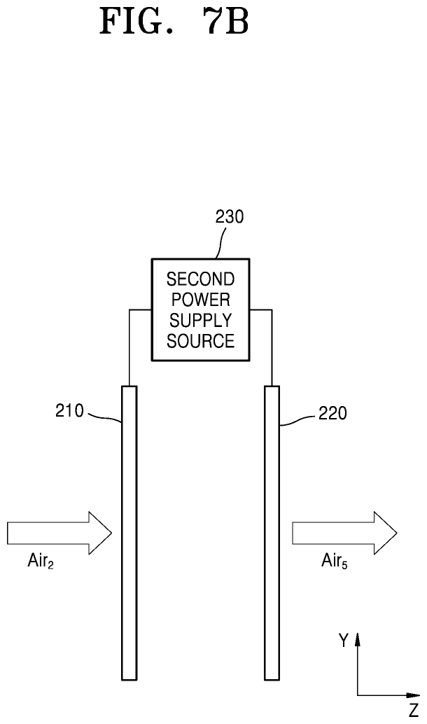

FIG. 7A is a schematic perspective view of an embodiment of a dust collector 20. FIG. 7B is a schematic side view of an embodiment of the dust collector 20.

Referring to FIGS. 7A and 7B, the dust collector 20 in an embodiment may include a 2-1 electrode 210 having a plate shape extending along one plane, a 2-2 electrode 220 disposed to face the 2-1 electrode 210, and a second power supply source 230 which applies a predetermined voltage to the 2-1 electrode 210 and the 2-2 electrode 220.

In an embodiment, the first purified air Air₂ discharged from the plasma reaction unit 10 may be introduced into the dust collector 20. As described above, the first purified air Air₂ may include fine dust charged by the discharge plasma. An electric field may be generated between the 2-1 electrode 210 to which a relatively high voltage is applied and the 2-2 electrode 220 to which a voltage of opposite polarity to the relatively high voltage is applied. The dust collector 20 may move fine dust charged by the discharge plasma with a force of an electric field generated between the 2-1 electrode 210 and the 2-2 electrode 220. Accordingly, the charged fine dust included in the first purified air Air₂ may be collected on either the 2-1 electrode 210 or the 2-2 electrode 220.

The 2-1 electrode 210 may have a plate shape extending along one plane (XY plane). In an embodiment, the 2-1 electrode 210 may extend along one plane (XY plane) perpendicular to one direction (Z direction) in which the first purified air Air₂ flows, for example. In an embodiment, the 2-1 electrode 210 may include a metal material capable of receiving relatively high voltage from the second power supply source 230. In addition, the 2-1 electrode 210 may have a porous plate shape including predetermined pores. In an embodiment, the 2-1 electrode 210 may include one or more of porous nickel foam, aluminum foam, copper foam, stainless steel foam, or iron foam, titanium foam, silver foam, carbon foam, and graphene foam. However, the disclosure is not limited thereto, and the 2-1 electrode 210 may have an arbitrary porous plate shape including a metal material. According to an example, because the 2-1 electrode 210 has a porous plate shape, the first purified air Air₂ introduced in one direction (Z direction) may move through the 2-1 electrode 210.

The 2-2 electrode 220 may have a plate shape extending along one plane (XY plane). In an embodiment, the 2-2 electrode 220 may extend along one plane (XY plane) perpendicular to one direction (Z direction) in which the first purified air (Air₂) flows, for example. In addition, the 2-2 electrode 220 may be spaced apart from the 2-1 electrode 210 at a predetermined interval in one direction (Z direction). In an embodiment, the 2-2 electrode 220 may include a metal material capable of receiving a relatively high voltage from the second power supply source 230. In addition, the 2-2 electrode 220 may have a porous plate shape including predetermined pores. In an embodiment, the 2-2 electrode 220 may include at least one of porous nickel foam, aluminum foam, copper foam, stainless steel foam, iron foam, titanium foam, silver foam, carbon foam, and graphene foam, for example. However, the disclosure is not limited thereto, and the 2-2 electrode 220 may have an arbitrary porous plate shape including a metal material.

According to an example, because the 2-2 electrode 220 has a porous plate shape, the first purified air Air₂ introduced in one direction (Z direction) may be discharged as the fifth purified air Air₅ through the 2-1 electrode 210. At this time, the 2-2 electrode 220 may operate as a dust collecting plate. Accordingly, the charged fine dust may be collected by the 2-2 electrode 220, and thus, the fifth purified air Air₅ from which the fine dust is removed may be discharged.

The 2-1 electrode 210 and the 2-2 electrode 220 may be fixed by a housing (not shown). The housing (not shown) may form an outer shape of the dust collector 20. According to an example, a dust collection room for performing electric dust collection is formed in the center of the housing (not shown) and an insulation room in which the 2-1 electrode 210 and the 2-2 electrode 220 are disposed on opposite sides of the dust collection room is formed, and thus, a space of the dust collection room may be separated from the outside. Although the housing (not shown) is not shown in the disclosure, an arbitrary support member forming the insulation room in which the 2-1 electrode 210 and the 2-2 electrode 220 are supported and the space is separated from the outside may be used as a housing (not shown).

The second power supply source 230 may apply a relatively high voltage between the 2-1 electrode 210 and the 2-2 electrode 220. The second power supply source 230 in an embodiment may include a sine wave AC power supply device and a transformer. The second power supply source 230 may continuously apply a relatively high voltage between the 2-1 electrode 210 and the 2-2 electrode 220 through the electrical system described above. In an embodiment, the voltage applied between the 2-1 electrode 210 and the 2-2 electrode 220 may be about 1 kV or more and about 100 kV or less, and a frequency may be about 10 Hz or more and about 100 Hz or less, but the disclosure is not limited thereto. In addition, a separation distance between the 2-1 electrode 210 and the 2-2 electrode 220 may be in a range from about 1 mm to about 100 mm, and accordingly, an electric field in a range of about 1 kV/cm to about 10 kV/cm may be applied between the 2-1 electrode 210 and the 2-2 electrode 220. However, the disclosure is not limited thereto, and the voltage applied by the second power supply source 230 and the electric field may be differently adjusted according to the size of the fine dust.

While the first purified air Air₂ passes between the 2-1 electrode 210 and the 2-2 electrode 220 to which a relatively high voltage is applied, an additional charge may take place to the fine dust charged by the plasma reaction unit 10. Accordingly, the charge amount of the fine dust included in the first purified air Air₂ and the charge amount of the fine dust passing through the 2-1 electrode 210 may be adjusted differently.

In an embodiment, when a first charge takes place to the first purified air Air₂ by the plasma reaction unit 10, dust collection for ultra-fine dust of about 0.3 μm or less may be achieved. However, in this case, dust collection for fine dust of about 10 μm or less may not be achieved. According to an example, when an additional charge takes place to the fine dust while the first purified air Air₂ passes between the 2-1 electrode 210 and the 2-2 electrode 220, dust collection for fine dust of about 10 μm or less may not be achieved. However, the disclosure is not limited thereto, and a voltage applied by the second power supply source 230 and an electric field accordingly may be differently adjusted according to the size of the fine dust. Accordingly, an additional charge amount that takes place while the first purified air Air₂ passes between the 2-1 electrode 210 and the 2-2 electrode 220 may also be differently adjusted.

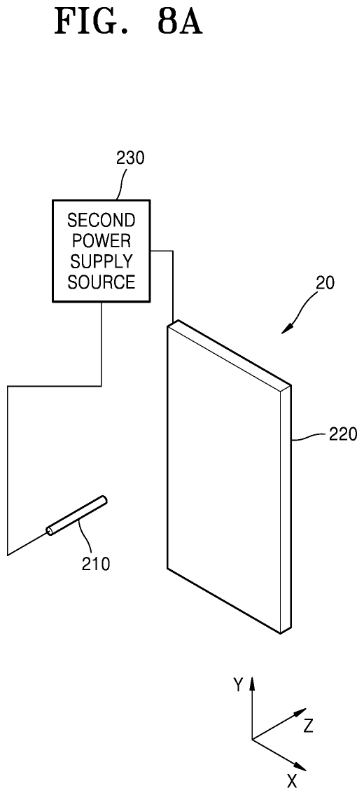

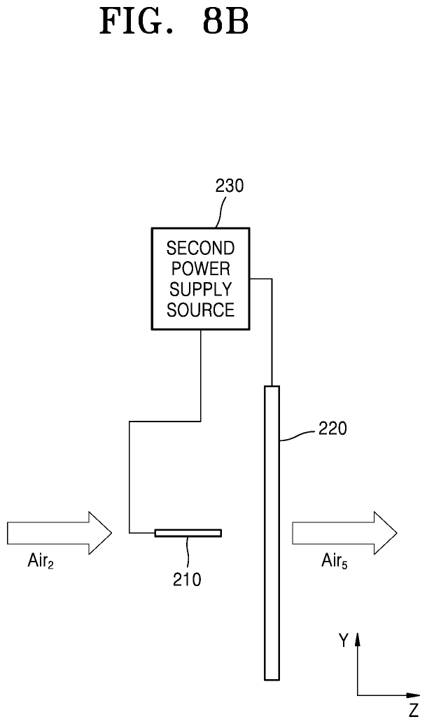

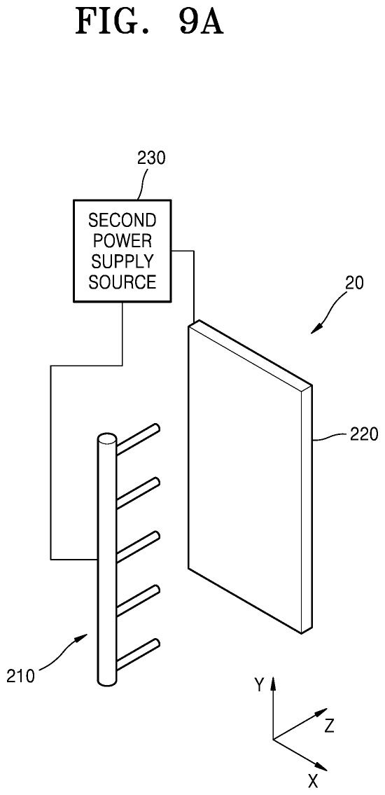

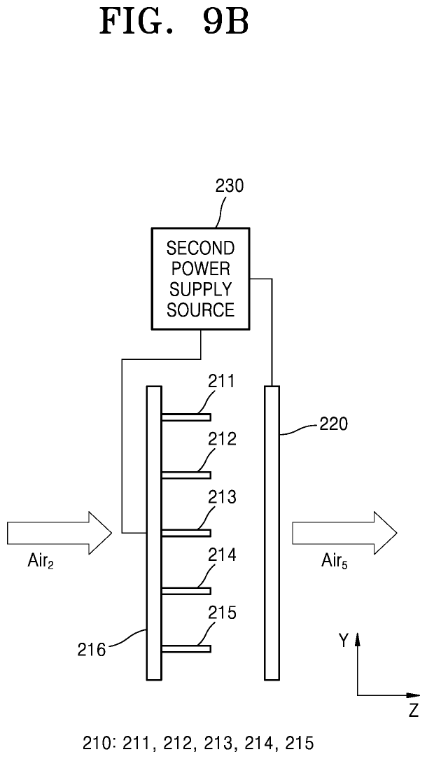

FIG. 8A is a schematic perspective view of an embodiment of a dust collector 20. FIG. 8B is a schematic side view of a dust collector 20. FIG. 9A is a schematic perspective view of an embodiment of the dust collector 20. FIG. 9B is a schematic side view of an embodiment of the dust collector 20.

Referring to FIGS. 8A and 8B, the dust collector 20 in an embodiment may include a 2-1 electrode 210 having a rod shape extending along one plane, a 2-2 electrode 220 disposed to face the 2-1 electrode 210, and a second power supply source 230 which applies a predetermined voltage to the 2-1 electrode 210 and the 2-2 electrode 220. Descriptions related to the 2-2 electrode 220 and the second power supply source 230, except for the 2-1 electrode 210, are the same as those of FIGS. 7A and 7B, and thus, the description thereof is omitted.

The 2-1 electrode 210 may have a rod shape extending in one direction. In an embodiment, the 2-1 electrode 210 may extend in the same direction as one direction (Z direction) in which the first purified air Air₂ flows, for example. In an embodiment, the 2-1 electrode 210 may include a metal material capable of receiving relatively high voltage from the second power supply source 230. In addition, the 2-1 electrode 210 may have a rod shape having a predetermined cross-sectional area. Accordingly, a relatively high electric field may be generated between one end of the 2-1 electrode 210 and the 2-2 electrode 220 compared to between the 2-1 electrode 210 and the 2-2 electrode 220 shown in FIG. 7A. Accordingly, in the process of passing the first purified air Air₂ between the 2-1 electrode 210 and the 2-2 electrode 220, the amount of additional charge for the fine dust may increase. An area of the electric field generated between the 2-1 electrode 210 and the 2-2 electrode 220 may decrease.

Referring to FIGS. 9A and 9B, the dust collector 20 in an embodiment may include a 2-1 electrode 210 having a rod shape extending along one plane, a 2-2 electrode 220 disposed to face the 2-1 electrode 210, and a second power supply source 230 which applies a predetermined voltage to the 2-1 electrode 210 and the 2-2 electrode 220. Descriptions related to the 2-2 electrode 220 and the second power supply source 230, except for the 2-1 electrode 210, are the same as those of FIGS. 7A and 7B, and thus, descriptions thereof are omitted.

The 2-1 electrode 210 may have a rod shape extending in one direction. In an embodiment, the 2-1 electrode 210 may be provided in plural and arranged to be spaced apart from each other with a predetermined interval therebetween. In an embodiment, the plurality of 2-1 electrodes 210 may include 2-11 electrodes 211 to 2-15 electrodes 215, for example. At this time, the 2-11 electrode 211 to the 2-15 electrode 215 may be arranged to be spaced apart with a predetermined interval therebetween in the other direction (Y direction) perpendicular to one direction (Z direction). Also, at this time, the 2-11 electrode 211 to 2-15 electrode 215 may be electrically connected to the second power supply source 230 while being supported by an electrode support 216.

In an embodiment, the plurality of 2-1 electrodes 210 may include a metal material capable of receiving relatively high voltage from the second power supply source 230. In addition, the plurality of 2-1 electrodes 210 may have a rod shape having a predetermined cross-sectional area. Accordingly, a relatively high electric field may be generated between one end of the plurality of 2-1 electrodes 210 and the 2-2 electrode 220 compared to between the 2-1 electrode 210 and the 2-2 electrode 220 shown in FIG. 7A having a plate shape. Accordingly, the amount of additional charge for the fine dust may increase while the first purified air Air₂ passes between the plurality of 2-1 electrodes 210 and 2-2 electrode 220. In addition, an area of the electric field generated between the plurality of 2-1 electrodes 210 and the 2-2 electrode 220 may be greater than the area of an electric field generated between the 2-1 electrode 210 and the 2-2 electrode 220 shown in FIG. 8A. Therefore, the amount of additional charge for a relatively large amount of fine dust may increase while the first purified air Air₂ passes between the plurality of 2-1 electrodes 210 and the 2-2 electrode 220.

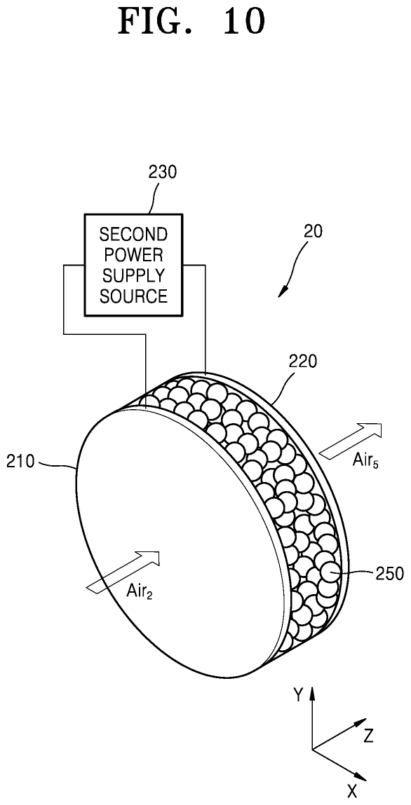

FIG. 10 is a schematic perspective view of a dust collector 20.

Referring to FIG. 10, the dust collector 20 in an embodiment includes a 2-1 electrode 210 having a plate shape extending along one plane, a 2-2 electrode 220 disposed to face the 2-1 electrode 210, and a second power supply source 230 which applies a predetermined voltage to the 2-1 electrode 210 and the 2-2 electrode 220. Except for a plurality of dielectric particles 250 disposed between the 2-1 electrode 210 and the 2-2 electrode 220, the configuration is the same as that of FIGS. 7A and 7B, and thus, the description thereof is omitted.

The plurality of dielectric particles 250 may be disposed between the 2-1 electrode 210 and the 2-2 electrode 220. The plurality of dielectric particles 250 in an embodiment may be polarized to attract charged contaminants. In an embodiment, the plurality of dielectric particles 250 may include a dielectric material that may be polarized between the 2-1 electrode 210 and the 2-2 electrode 220, for example. In an embodiment, the plurality of dielectric particles 250 may include a metal oxide, metal nitride, or polymer, e.g., at least one of silicon oxide, boron oxide, aluminum oxide, manganese oxide, titanium oxide, barium oxide, copper oxide, magnesium oxide, zinc oxide, zirconium oxide, yttrium oxide, calcium oxide, nickel oxide, iron oxide, PTFE, and rubber, or one or more of combinations of the above materials.

Also, in an embodiment, the plurality of dielectric particles 250 may form predetermined pores, and thus, a residence time and contact area for the contaminated air Air₁ between the 2-1 electrode 210 and the 2-2 electrode 220 may be increased. In an embodiment, the plurality of dielectric particles 250 may have a bead shape having a predetermined particle diameter, e.g., an average diameter in a range of about 1 mm to about 30 mm, for example. However, the disclosure is not limited thereto, and the plurality of dielectric particles 250 may have other three-dimensional shapes, such as an arbitrary rectangular parallelepiped.

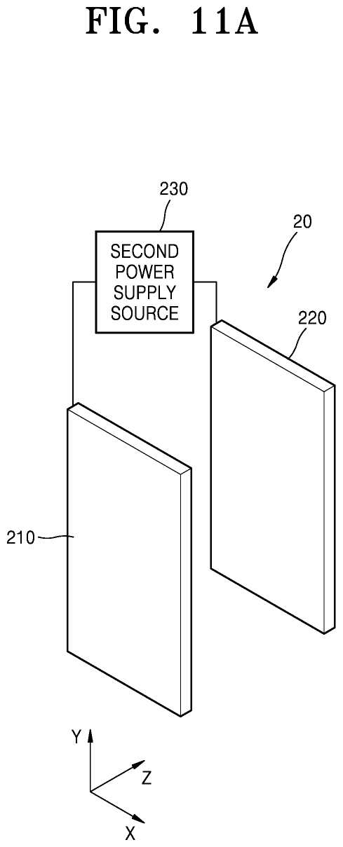

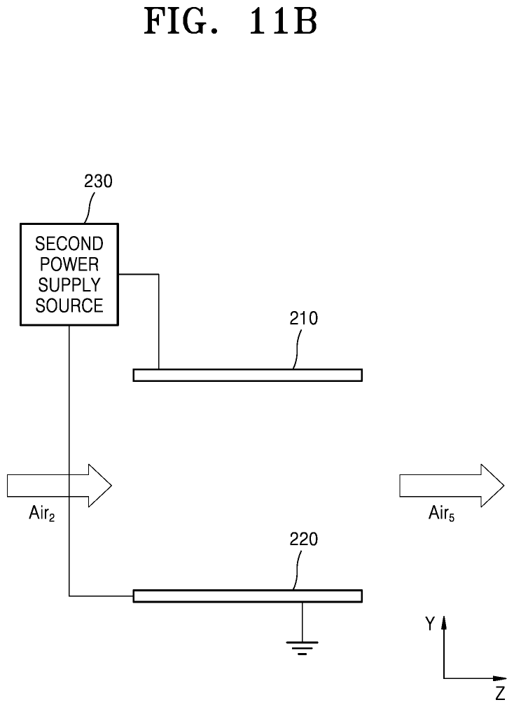

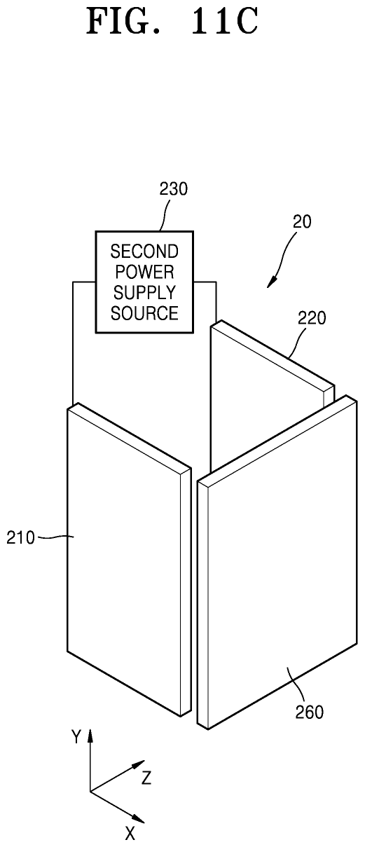

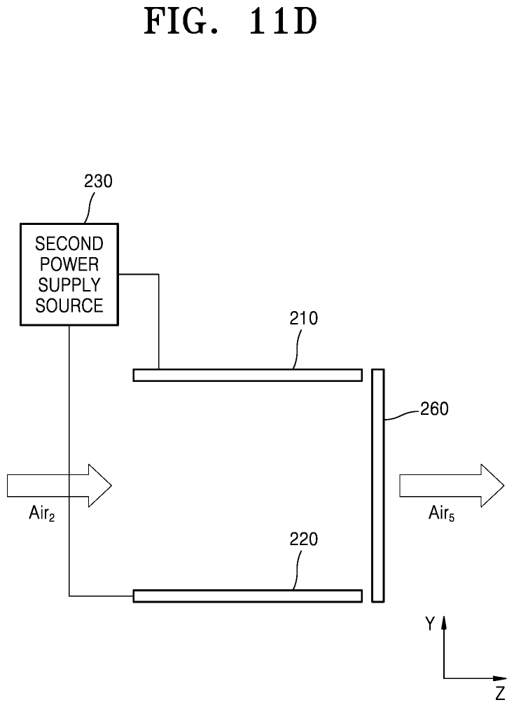

FIG. 11A is a schematic perspective view of an embodiment of a dust collector 20. FIG. 11B is a schematic side view of the dust collector 20.

Referring to FIGS. 11A and 11B, the dust collector 20 in an embodiment may include a 2-1 electrode 210 having a plate shape extending along one plane, a 2-2 electrode 220 disposed to face the 2-1 electrode 210, and a second power supply source 230 which applies a predetermined voltage to the 2-1 electrode 210 and the 2-2 electrode 220.

In an embodiment, the first purified air Air₂ discharged from the plasma reaction unit 10 may be introduced into the dust collector 20. As described above, the first purified air Air₂ may include fine dust charged by discharge plasma. An electric field may be generated between the 2-1 electrode 210 to which a relatively high voltage is applied and the 2-2 electrode 220 that is grounded. The dust collector 20 may move fine dust charged by the plasma reaction unit 10 with a force of an electric field generated between the 2-1 electrode 210 and the 2-2 electrode 220. Accordingly, the charged fine dust included in the first purified air Air₂ may be collected on either the 2-1 electrode 210 or the 2-2 electrode 220.

The 2-1 electrode 210 may have a plate shape extending along one plane (XZ plane). In an embodiment, the 2-1 electrode 210 may extend along one plane (XZ plane) parallel to one direction (Z direction) in which the first purified air Air₂ flows, for example. In an embodiment, the 2-1 electrode 210 may include a metal material capable of receiving relatively high voltage from the second power supply source 230.

The 2-2 electrode 220 may have a plate shape extending along one plane (XZ plane). In an embodiment, the 2-2 electrode 220 may extend along one plane (XZ plane) parallel to one direction (Z direction) in which the first purified air Air₂ flows, for example. In addition, the 2-2 electrode 220 may be spaced apart from the 2-1 electrode 210 at a predetermined interval in one direction (Y direction). According to an example, the 2-2 electrode 220 may include a metal material and may be grounded. According to an example, the 2-1 electrode 210 and the 2-2 electrode 220 are arranged to be spaced apart from each other with a predetermined interval in one direction (Y direction), and thus, the first purified air Air₂ introduced along one direction (Z direction) may move between the 2-1 electrode 210 and the 2-2 electrode 220.

The 2-1 electrode 210 and the 2-2 electrode 220 may be fixed by a housing (not shown). The housing (not shown) may form an outer shape of the dust collector 20. In an embodiment, a dust collection room for performing electric dust collection is formed in the center of the housing (not shown) and an insulation room in which the 2-1 electrode 210 and the 2-2 electrode 220 are disposed on opposite sides of the dust collection room is formed, and thus, a space of the dust collection room may be separated from the outside. Although the housing (not shown) is not shown in the disclosure, an arbitrary support member forming the insulation room in which the 2-1 electrode 210 and the 2-2 electrode 220 are supported and the space is separated from the outside may be used as a housing (not shown).

The second power supply source 230 may apply a relatively high voltage between the 2-1 electrode 210 and the 2-2 electrode 220. The second power supply source 230 in an embodiment may include a sine wave AC power supply device and a transformer. The second power supply source 230 may continuously apply a relatively high voltage between the 2-1 electrode 210 and the 2-2 electrode 220 through the electrical system described above. In an embodiment, the voltage applied between the 2-1 electrode 210 and the 2-2 electrode 220 may be about 1 kV or more and about 100 kV or less, and a frequency may be about 10 Hz or more and about 100 Hz or less, but the disclosure is not limited thereto. In addition, a separation distance between the 2-1 electrode 210 and the 2-2 electrode 220 may be in a range from about 1 mm to about 100 mm, and accordingly, an electric field in a range of about 1 kV/cm to about 10 kV/cm may be applied between the 2-1 electrode 210 and the 2-2 electrode 220. However, the disclosure is not limited thereto, and the voltage applied by the second power supply source 230 and the electric field may be differently adjusted according to the size of the fine dust.

In an embodiment, the fine dust included in the first purified air Air₂ charged by the plasma reaction unit 10 may be collected on either the 2-1 electrode 210 or the 2-2 electrode 220 by a force of an electric field generated between the 2-1 electrode 210 to which a relatively high voltage is applied and the 2-2 electrode 220 that is grounded. The first purified air Air₂ introduced in one direction (Z direction) may be discharged as fifth purified air Air₅ from which the fine dust is removed in a process of moving between the 2-1 electrode 210 and the 2-2 electrode 220.

FIG. 11C is a schematic perspective view of an embodiment of a dust collector 20. FIG. 11D is a schematic side view of the dust collector 20.

Referring to FIGS. 11C to 11D, the dust collector 20 in an embodiment may include a 2-1 electrode 210 having a plate shape extending along one plane, a 2-2 electrode 220 disposed to face the 2-1 electrode 210, a second power supply source 230 which applies a predetermined voltage to the 2-1 electrode 210 and the 2-2 electrode 220, and a dust collecting plate 260. Except for the 2-2 electrode 220 and the dust collecting plate 260, the rest is substantially the same as that of FIGS. 11A and 11B, and thus, the description thereof is omitted.

The 2-2 electrode 220 may have a plate shape extending along one plane (XZ plane). In an embodiment, the 2-2 electrode 220 may extend along one plane (XZ plane) parallel to one direction (Z direction) in which the first purified air Air₂ flows. In addition, the 2-2 electrode 220 may be spaced apart from the 2-1 electrode 210 at a predetermined interval in one direction (Y direction), for example. In an embodiment, the 2-2 electrode 220 includes a metal material, and a voltage of opposite polarity to the relatively high voltage applied to the 2-1 electrode 210 may be applied.

The dust collecting plate 260 may have a plate shape extending along one plane (XY plane). In an embodiment, the dust collecting plate 260 may extend along one plane (XY plane) perpendicular to a moving direction (Z direction) of the first purified air Air₂, for example. In addition, the dust collecting plate 260 may be disposed at rear ends of the 2-1 electrode 210 and the 2-2 electrode 220 in the moving direction (Z direction) of the first purified air Air₂.

In an embodiment, the dust collecting plate 260 may include a porous plate shape including predetermined pores. In an embodiment, the dust collecting plate 260 may include at least one of porous nickel foam, aluminum foam, copper foam, stainless steel foam, iron foam, titanium foam, silver foam, carbon foam, and graphene foam, for example. However, the disclosure is not limited thereto, and the dust collecting plate 260 may have an arbitrary porous plate shape including a metal material. According to an example, because the dust collecting plate 260 has a porous plate shape, the first purified air Air₂ introduced in one direction (Z direction) may be discharged as a fifth purified air Air₅ through the dust collecting plate 260.

While the first purified air Air₂ passes between the 2-1 electrode 210 and the 2-2 electrode 220 to which a relatively high voltage is applied, an additional charge may take place to the fine dust charged by the plasma reaction unit 10. Accordingly, the charge amount of the fine dust included in the first purified air Air₂ and the charge amount of the fine dust passing between the 2-1 electrode 210 and the 2-2 electrode 220 may be adjusted differently.

In an embodiment, when a first charge takes place to the first purified air Air₂ by the plasma reaction unit 10, dust collection for ultra-fine dust of about 0.3 μm or less may be achieved by the dust collecting plate 260. However, in this case, dust collection for fine dust of about 10 μm or less may not be achieved. According to an example, when an additional charge takes place to the fine dust while the first purified air Air₂ passes between the 2-1 electrode 210 and the 2-2 electrode 220, dust collection for fine dust of about 10 μm or less may not be achieved by the 2-2 electrode 220 which is a dust collecting plate. However, the disclosure is not limited thereto, and a voltage applied by the second power supply source 230 and an electric field accordingly may be differently adjusted according to the size of the fine dust. Accordingly, an additional charge amount that takes place while the first purified air Air₂ passes between the 2-1 electrode 210 and the 2-2 electrode 220 may also be differently adjusted.

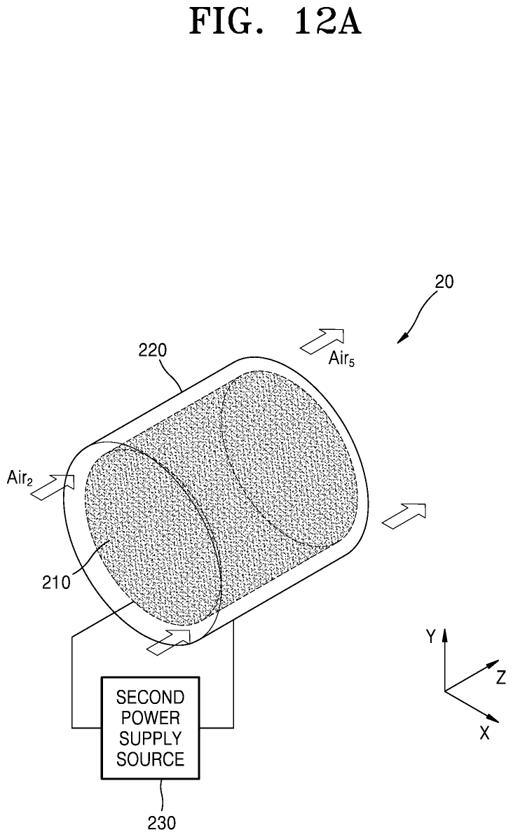

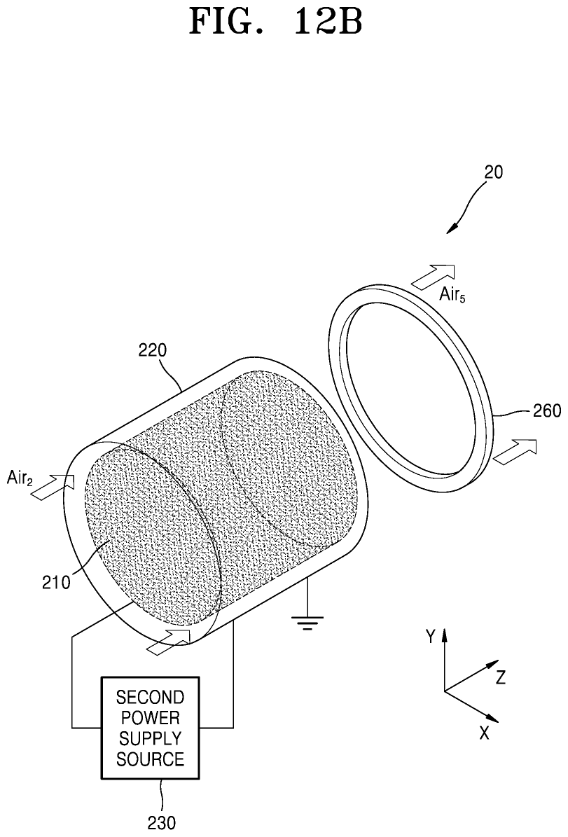

FIG. 12A is a schematic perspective view of an embodiment of a dust collector 20.

Referring to FIG. 12A, the dust collector 20 in an embodiment includes a 2-1 electrode 210 having a rod shape mainly extending in one direction (Z direction), a 2-2 electrode 220 having a cylindrical shape mainly extending in one direction (Z direction), and a second power supply source 230 which applies a predetermined voltage to the 2-1 electrode 210 and the 2-2 electrode 220. Except for the shapes of the 2-1 electrode 210 and the 2-2 electrode 220, the rest of the configuration is the same as that of FIGS. 11A and 11B, and thus, the description thereof is omitted.

The 2-1 electrode 210 may have a rod shape extending in the same direction as the moving direction (Z direction) of the first purified air Air₂. In this case, the 2-1 electrode 210 may be disposed inside the 2-2 electrode 220 having a cylindrical shape. The first purified air Air₂ in an embodiment may move between the 2-1 electrode 210 and the 2-2 electrode 220. At this time, fine dust included in the first purified air Air₂ is collected on either one of the 2-1 electrode 210 or the 2-2 electrode 220, and thus, purified fifth purified air Air₅ may be discharged.

FIG. 12B is a schematic perspective view of an embodiment of a dust collector 20.

Referring to FIG. 12B, the dust collector 20 in an embodiment includes a 2-1 electrode 210 having a rod shape mainly extending in one direction (Z direction), a 2-2 electrode 220 having a cylindrical shape mainly extending in one direction (Z direction), a second power supply source 230 which applies a predetermined voltage to the 2-1 electrode 210 and the 2-2 electrode 220, and a dust collecting plate 260. Except for the shapes of the 2-1 electrode 210, the 2-2 electrode 220, and the dust collecting plate 260, the rest of the configuration is the same as that of FIGS. 11C and 11D, and thus, the description thereof is omitted.

The 2-1 electrode 210 may have a rod shape extending in the same direction as the moving direction (Z direction) of the first purified air Air₂. In this case, the 2-1 electrode 210 may be disposed inside the 2-2 electrode 220 having a cylindrical shape. The dust collecting plate 260 may include a porous plate shape corresponding to a region between the 2-1 electrode 210 and the 2-2 electrode 220. In an embodiment, the dust collecting plate 260 may have a porous plate shape corresponding to the region between the 2-1 electrode 210 and the 2-2 electrode 220. However, the disclosure is not limited thereto, and the dust collecting plate 260 may have a plate shape extending along one plane (XY plane).

According to an example, because the dust collecting plate 260 has a porous plate shape, the first purified air Air₂ introduced in one direction (Z direction) may be discharged as a fifth purified air Air₅ through the dust collecting plate 260.

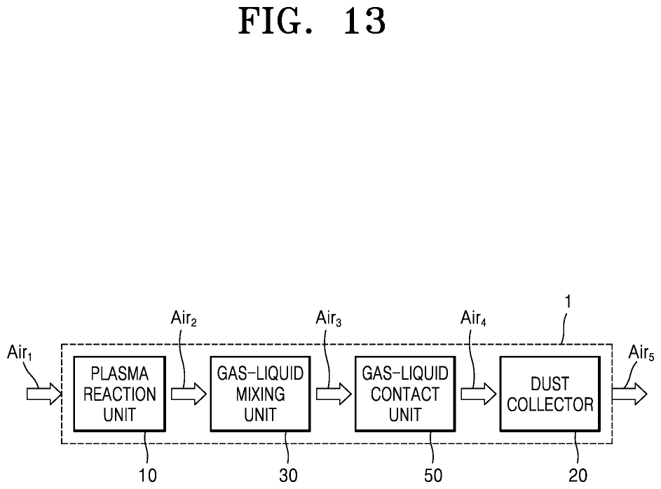

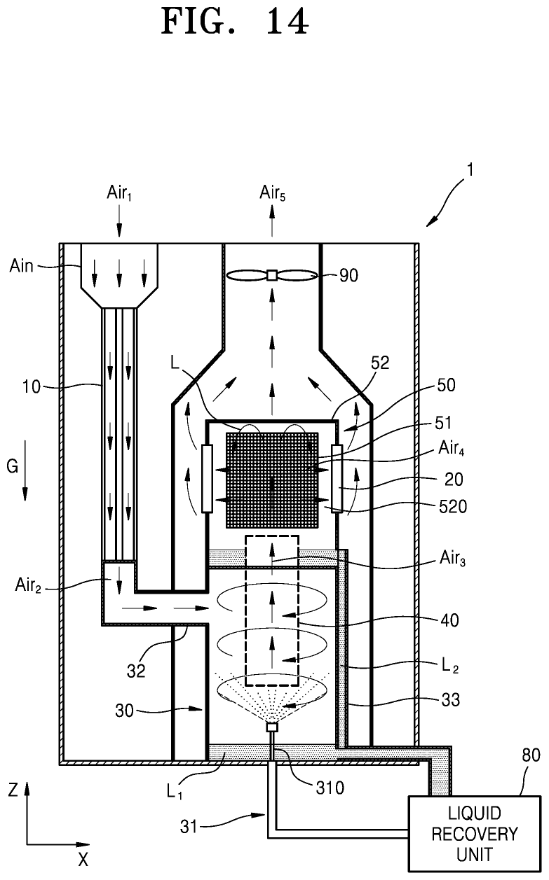

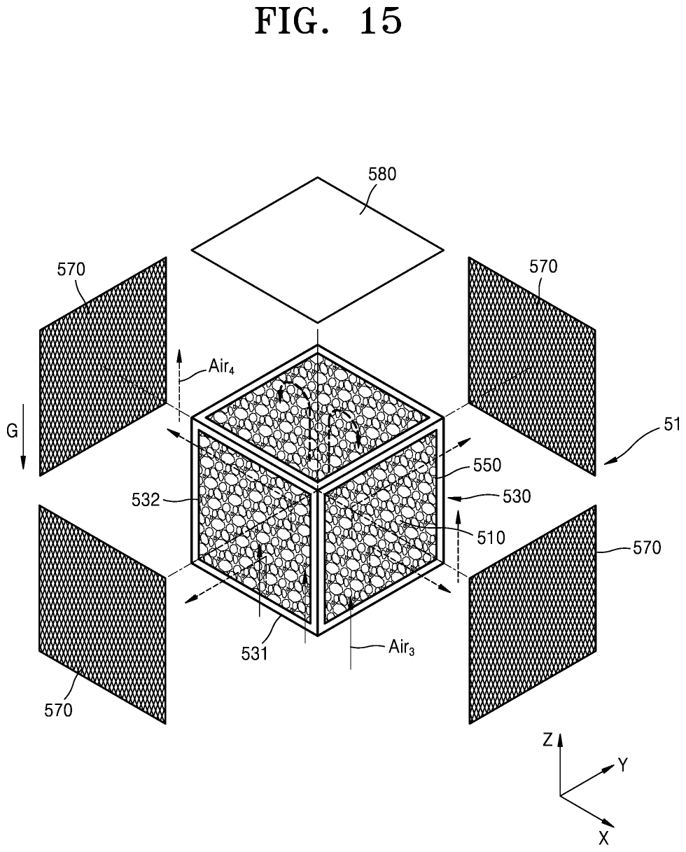

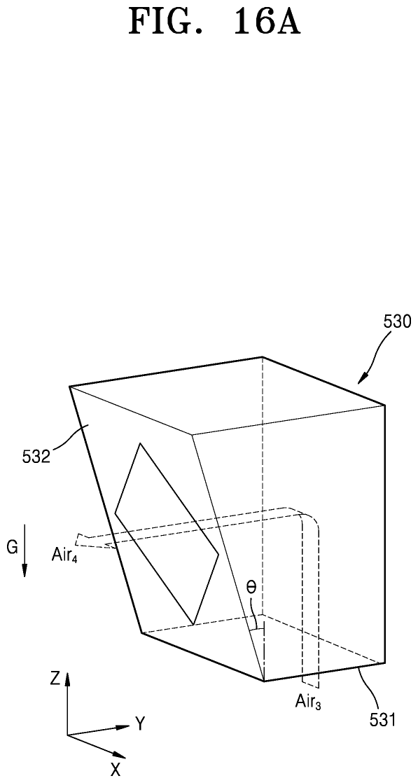

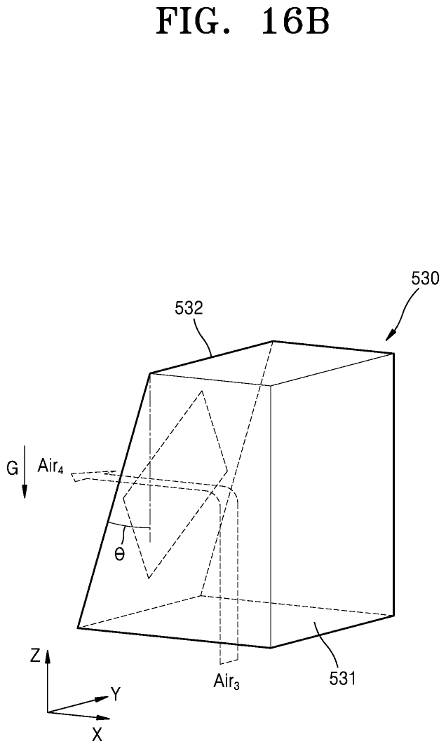

FIG. 13 is a block diagram of an embodiment of an air purifier 1. FIG. 14 is a schematic diagram of a configuration of the air purifier 1. FIG. 15 is a perspective view of an embodiment of an impactor. FIGS. 16A and 16B are schematic perspective views of an embodiment of an impactor.

Referring to FIGS. 13 and 14, the air purifier 1 in an embodiment may include an air inlet Aᵢₙ into which contaminated air Air₁ is introduced; a plasma reaction unit 10 connected in fluid communication with the air inlet Aᵢₙ and purifying the contaminated air Air₁ using discharge plasma; a gas-liquid mixing unit 30 that is connected in fluid communication with the plasma reaction unit 10 and mixes liquid droplets with first purified air Air₂ by spraying droplets; a fluid communication unit 40 disposed between the gas-liquid mixing unit 30 and a gas-liquid contact unit 50 to be described below; the gas-liquid contact unit 50 connected in fluid communication with the gas-liquid mixing unit 30, collecting droplets included in a gas-liquid mixed fluid Air₃, and separating a fourth purified air Air₄ and a liquid L₂, and a dust collector 20.

In the illustrated embodiment, the plasma reaction unit 10, the gas-liquid mixing unit 30, the gas-liquid contact unit 50, and the dust collector 20 are sequentially disposed, but the disclosure is not limited thereto. In the air purifier 1 in another embodiment, the gas-liquid mixing unit 30, the gas-liquid contact unit 50, the plasma reaction unit 10, and the dust collector 20 may be sequentially disposed. Descriptions related to the plasma reaction unit 10 and the dust collector 20 are substantially the same as those described in FIGS. 1 to 12B, and thus, the description thereof is omitted.

In an embodiment, the gas-liquid mixing unit 30 and the gas-liquid contact unit 50 may be sequentially disposed in a direction opposite to the direction of gravity G. At this time, the fluid communication unit 40 may extend in the direction of gravity G and may be disposed between the gas-liquid mixing unit 30 and the gas-liquid contact unit 50. The fluid communication unit 40 in an embodiment may be used as a movement path through which a mixed fluid moves from the gas-liquid mixing unit 30 to the gas-liquid contact unit 50.

The gas-liquid mixing unit 30 in an embodiment may be connected in fluid communication with the plasma reaction unit 10. Accordingly, the first purified air Air₂ passing through the plasma reaction unit 10 may flow into the gas-liquid mixing unit 30 and be mixed with fine droplets. In an embodiment, the gas-liquid mixing unit 30 may include a droplet ejection device 31 for spraying fine droplets, a fluid mixing device 32 for mixing the fine droplets and the first purified air Air₂, and a gas-liquid mixing unit housing 33.

The droplet ejection device 31 may eject droplets, e.g., water into the gas-liquid mixing unit housing 33. The droplet ejection device 31 may include at least one ejection nozzle 310. In an embodiment, water stored in a liquid recovery unit 80 is pressurized by a pump (not shown) and ejected into the gas-liquid mixing unit housing 33 in the form of fine droplets through the at least one ejection nozzle 310, for example. In this process, some of fine dust included in the first purified air Air₂ is collected by droplets. Accordingly, a gas-liquid mixed fluid in which air and droplets are mixed may be formed in the gas-liquid mixing unit housing 33.

The at least one ejection nozzle 310 may be disposed in any area of the gas-liquid mixing unit housing 33. Accordingly, the fine droplets passing through at least one ejection nozzle 310 may be ejected to an arbitrary area of the gas-liquid mixing unit housing 33. According to an example, the first purified air Air₂ that has passed through the plasma reaction unit 10 may form a gas-liquid mixed fluid Air₅ by mixing with fine droplets ejected to an arbitrary area.

In the specification, the gas-liquid mixed fluid Air₅ is a fluid in which the first purified air Air₂ passing through the plasma reaction unit 10 is mixed with fine liquid droplets. Also, according to an example, when ozone (O₃) is included in the first purified air Air₂, the gas-liquid mixed fluid Air₃ includes ozone water in which ozone (O₃) and fine droplets, e.g., moisture droplets are combined. When ozone water is included in the gas-liquid mixed fluid Air₃, contaminants in the water may be removed and bacteria may be inactivated by the oxidizing power of the ozone water.

The fluid mixing device 32 may generate a fluid flow for mixing the first purified air Air₂ passing through the plasma reaction unit 10 and the fine droplets ejected from the at least one ejection nozzle 310. In an embodiment, the fluid mixing device 32 may be a fluid pressurizing device that forms a vortex inside the gas-liquid mixing unit housing 33, for example. However, the disclosure is not limited thereto. In an embodiment, as shown in FIG. 14, when the plasma reaction unit 10, the gas-liquid mixing unit 30, the gas-liquid contact unit 50, and the dust collector 20 are sequentially disposed, and the movement paths of a fluid are interconnected, a pressure application unit for each of the plasma reaction unit 10, the gas-liquid mixing unit 30, the gas-liquid contact unit 50, and the dust collector 20 may be combined into one. In an embodiment, a pressurizing member 90, e.g., a blower, disposed in a discharge path of purified air may be substituted for a pressure application unit for the plasma reaction unit 10, the gas-liquid mixing unit 30, the gas-liquid contact unit 50, and the dust collector 20, for example. In this case, a separate fluid mixing device 32 may not be disposed in the gas-liquid mixing unit 30.

In an embodiment, the first purified air Air₂ flowing into the gas-liquid mixing unit housing 33 may form a vortex. According to an example, as the first purified air Air₂ and the fine droplets rotate at a substantially high speed along a sidewall of the gas-liquid mixing unit housing 33 by centrifugal force, a mixing speed of the first purified air Air₂ with the fine droplets may increase. In an embodiment, the first purified air Air₂ and the fine droplets ejected from the at least one ejection nozzle 310 may rotate at a substantially high speed along the sidewall of the gas-liquid mixing unit housing 33, for example. At this time, a centrifugal force acts on the first purified air Air₂ and the fine droplets, and accordingly, the number of contacts between the first purified air Air₂ and the fine droplets on the sidewall of the gas-liquid mixing unit housing 33 may increase. Accordingly, a gas-liquid mixed fluid Air₃ in which the fine droplets and the first purified air Air₂ are mixed may be more easily formed.

Some of the gas-liquid mixed fluid Air₃ may combine with other gas-liquid mixed fluid Air₃ while downwardly rotating along the sidewall of the gas-liquid mixing unit housing 33. The gas-liquid mixed fluid Air₅ converted to a liquid L₁ state having a predetermined mass or more by combining with other gas-liquid mixed fluids Air₅ may be moved to the liquid recovery unit 80.

In an embodiment, the liquid L₁ collected by the liquid recovery unit 80 may include contaminants. At this time, an arbitrary purification device capable of purifying contaminants collected in the liquid L₁ may be disposed in the liquid recovery unit 80. The liquid L₁ from which contaminants are removed by the arbitrary purification device disposed in the liquid recovery unit 80 may be supplied to the droplet ejection device 31 and reused by a pressure means, such as a pump (not shown). The gas-liquid mixed fluid Air₃ that is not combined with other gas-liquid mixed fluids Air₃ and reaches a bottom of the gas-liquid mixing unit housing 33 may move to the gas-liquid contact unit 50 through the fluid communication unit 40.

The fluid communication unit 40 may be disposed between the gas-liquid mixing unit 30 and the gas-liquid contact unit 50 to transfer the gas-liquid mixed fluid Air₃ generated in the gas-liquid mixing unit 30 to the gas-liquid contact unit 50. In an embodiment, the fluid communication unit 40 may be provided as a hollow conduit extending in the direction of gravity. In an embodiment, as described above, when a vortex is formed inside the gas-liquid mixing unit housing 33 by the fluid mixing device 32, the fluid communication unit 40 may be a vortex finder, for example. In an embodiment, when the fluid communication unit 40 is provided as a vortex finder, a pressure drop may occur in an inner region of a bottom portion of the gas-liquid mixing unit housing 33. Accordingly, the gas-liquid mixed fluid Air₅ may rise in a direction opposite to the direction of gravity G and be transferred to the gas-liquid contact unit 50.

Referring to FIGS. 14 and 15, the gas-liquid contact unit 50 in an embodiment is connected in fluid communication with the gas-liquid mixing unit 30, and may include an impactor 51 that collects droplets included in the gas-liquid mixed fluid Air₃ and a gas-liquid contact unit case 52. In an embodiment, the impactor 51 may include a plurality of micro-channels 510. The gas-liquid mixed fluid Air₃ introduced from the gas-liquid mixing unit 30 may pass through the plurality of micro-channels 510. In an embodiment, the gas-liquid contact unit case 52 may be an accommodation member accommodating the impactor 51. The gas-liquid contact unit case 52 in an embodiment may have a cube shape as shown in FIG. 15, but the disclosure is not limited thereto. A gas-liquid contact unit case 52 may be disposed with a discharge path 520 through which a gas described below is discharged to the outside.

The impactor 51 in an embodiment may include a porous member that collects fine droplets included in the gas-liquid mixed fluid Air₃. In an embodiment, the porous member filled in the impactor 51 may be a filling member having a predetermined porosity. In an embodiment, the porous member may include at least one of a porous foam block, a fine filler, or a porous mesh screen, for example. At this time, the porosity of the porous member may be about 0.5 or more. In this case, the plurality of micro-channels 510 formed in the impactor 51 may be formed by spacing between the porous members. Hereinafter, as the porous member provided in the impactor 51, a fine filler and a porous mesh screen supporting the fine filler are shown in an embodiment, but the disclosure is not limited thereto.

In an embodiment, the impactor 51 may include a housing 530, a plurality of fillers 550 filled in the housing 530, and a mesh screen 570 supporting the plurality of fillers 550. The housing 530 in an embodiment may be provided in a rectangular parallelepiped frame structure. The plurality of fillers 550 may be beads, for example. The beads may include, e.g., glass or a metal. A diameter of the plurality of beads may be uniform or non-uniform. The plurality of beads may be regularly or irregularly packed inside the housing 530. The plurality of beads may be stacked in one or more layers in a flow direction of the gas-liquid mixed fluid Air₃, e.g., in the direction of gravity G. The plurality of beads may be packed inside the housing 530 in various forms. The packing form of the plurality of beads may be in various structures, e.g., a simple cubic primitive centered cubic (“PCC”) structure, a face centered cubic (“FCC”) structure, a cubic structure such as a body centered cubic (“BCC”) structure, or a hexagonal closed-packed (“HCP”) structure, etc.

In an embodiment, a surface of the filler 550 may be treated to have incompatibility with liquid droplets so that the liquid droplets are easily separated from the surface of the filler 550. In an embodiment, the surface of filler 550 may be treated to be hydrophobic, for example. In order to increase the hydrophobic treated surface area, the surface of the filler 550 may be roughened before the hydrophobic treatment.

The housing 530 in an embodiment may include a fluid inlet 531 through which the gas-liquid mixed fluid Air₅ is introduced and a liquid L₂ is discharged in the direction of gravity G, and a gas outlet 532, through which a fourth purified air Air₄ that is not collected by the porous member among the gas-liquid mixed fluid Air₃, is discharged. In an embodiment, the fluid inlet 531 may be disposed in the direction of gravity G, e.g., on a lower surface of the housing 530 so that the gas-liquid mixed fluid Air₃ is introduced and the liquid L₂ is discharged in the direction of gravity G. In this case, the gas outlet 532 may be disposed in a direction different from the direction of gravity G, e.g., on a side surface of the housing 530 so that the fourth purified air Air₄ may be discharged. An upper surface of the housing 530 may be provided with a sealed plate 580 so that the gas-liquid mixed fluid Air₅ does not escape the impactor 51. However, the disclosure is not limited thereto, and the upper surface of the housing 530 may also have the gas outlet 532 so that the fourth purified air Air₄ may be discharged.

The dust collector 20 in an embodiment may be connected in fluid communication with the gas-liquid contact unit 50. In an embodiment, the dust collector 20 may be connected in fluid communication with the gas outlet 532 of the impactor 51, for example. Accordingly, the dust collector 20 may collect fine dust included in the fourth purified air Air₄ and discharge a fifth purified air Air₅. In an embodiment, one or more of the 2-1 electrode 210 or the 2-2 electrode 220 included in the dust collector 20 shown in FIGS. 1 to 12B is disposed on a surface of the gas outlet 532. However, the disclosure is not limited thereto, and when a separate flow passage guide is included in the dust collector 20, the dust collector 20 may be spaced apart from the gas outlet 532. Because the technical features of collecting fine dust using the dust collector 20 have been described with reference to FIGS. 1 to 12B, the description thereof is omitted.

In an embodiment, the impactor 51 may have either a polygonal column shape or a cylindrical shape. In an embodiment, when the impactor 51 has a square pillar shape as shown in FIG. 15, the housing 530 may also be provided in a square pillar shape, for example. At this time, the fluid inlet 531 may be disposed on a lower surface of the housing 530. In addition, the gas outlet 532 may be disposed on four side surfaces of the housing 530.

In an embodiment, the impactor 51 may include an inclined surface having a predetermined inclination angle θ with respect to the direction of gravity G. In an embodiment, one or more of the gas outlets 532 included in the impactor 51 may be an inclined surface having a predetermined inclination angle θ with respect to the direction of gravity G. In an embodiment, as shown in FIGS. 16A and 16B, the gas outlet 532 may be an inclined surface inclined at a predetermined inclination angle θ in a clockwise or counterclockwise direction with respect to the direction of gravity G, for example. In an embodiment, the predetermined inclination angle θ may be greater than 0 degree and less than 45 degrees, but the disclosure is not limited thereto. Because the impactor 51 includes an inclined surface having a predetermined inclination angle θ with respect to the direction of gravity G, a liquid may be easily discharged downward from the impactor 51. Accordingly, the dust collection efficiency of the air purifier 1 may be improved.

In an embodiment, the mesh screen 570 may be disposed in the gas outlet 532. In an embodiment, the mesh screen 570 may be treated to have incompatibility with the liquid L₂. Accordingly, pores of the mesh screen 570 may be prevented from being clogged with liquid.

As described above, the gas-liquid mixed fluid Air₃ introduced from the gas-liquid mixing unit 30 passes through micro-channels formed by the plurality of fillers 550. In this process, droplets are collected on surfaces of the micro-channels, that is, on surfaces of the plurality of fillers 550. Droplets fall in the direction of gravity G. The liquid L₂ falling in the direction of gravity G may pass through the mesh screen 570 and be recovered to the liquid recovery unit 80. At this time, the fourth purified air Air₄ that is not collected by the porous member among the gas-liquid mixed fluid Air₅ may pass through the gas outlet 532 and be discharged. At this time, fine dust of the fourth purified air Air₄ is additionally collected through the dust collector 20. The fifth purified air Air₅ passing through the dust collector 20 may be final purified air after all purification processes have been completed. At this time, the pressurizing member 90, e.g., a blower, may apply pressure to the fifth purified air Air₅ so that the fifth purified air Air₅ is discharged in a direction opposite to the direction of gravity G.

By the embodiments of the air purifier described above, fine dust and contaminants may be ionized or decomposed by discharge plasma.

Also, in embodiments of the air purifier, the fine dust charged by the discharge plasma may be collected and removed by the dust collector. In addition, fine dust of various sizes may be collected by additionally charging the fine dust by the dust collector.

Further, in embodiments of the air purifier, after being collected in the liquid passing through the gas-liquid mixing unit and the gas-liquid contact unit, the gas may be easily discharged from the air purifier.

Therefore, fine dust and contaminants of various sizes and types in the air may be removed, and thus, a relatively high contaminant removal performance may be realized.

While the air purifier has been described with reference to the embodiments shown in the drawings. However, it will be understood by those of ordinary skill in the art that various changes in form and details may be made therein without departing from the spirit and scope of the disclosure. Accordingly, the scope of the disclosure is defined not by the detailed description of the invention but by the appended claims.

It should be understood that embodiments described above should be considered in a descriptive sense only and not for purposes of limitation. Descriptions of features or advantages within each embodiment should typically be considered as available for other similar features or advantages in other embodiments. While embodiments have been described with reference to the drawing figures, it will be understood by those of ordinary skill in the art that various changes in form and details may be made therein without departing from the spirit and scope as defined by the following claims.

What is claimed is:

1. An air purifier for purifying contaminated air by removing air contaminants, the air purifier comprising:
an air inlet through which the contaminated air is introduced;
a plasma reaction unit connected in fluid communication with the air inlet and including a predetermined discharge region which generates discharge plasma; and
a dust collector which is connected in fluid communication with the plasma reaction unit and collects and removes the contaminants from first purified air discharged from the plasma reaction unit.

2. The air purifier of claim 1, wherein the plasma reaction unit includes:
a reactor having a hollow shape and mainly extending in a direction;
a 1-1 electrode disposed inside the reactor;
a 1-2 electrode spaced apart from the 1-1 electrode with a predetermined gap therebetween; and
a first power supply source which applies a predetermined voltage to the 1-1 electrode and the 1-2 electrode,
wherein the reactor comprises at least one cross section of a circular or polygonal shape.

3. The air purifier of claim 2, wherein the plasma reaction unit is provided in plural, and
a plurality of reactors included in the plurality of plasma reaction units, respectively, is adjacent to each other.

4. The air purifier of claim 3, further comprising:
a coolant passage disposed between the plurality of reactors respectively included in the plurality of plasma reaction units; and
a coolant which moves along the coolant passage.

5. The air purifier of claim 1, wherein the dust collector includes:
a 2-1 electrode having a plate shape extending along one plane;
a 2-2 electrode disposed which faces the 2-1 electrode and having a plate shape extending along the one plane; and
a second power supply source which applies a predetermined voltage to the 2-1 electrode and the 2-2 electrode.

6. The air purifier of claim 5, wherein the 2-1 electrode and the 2-2 electrode are porous plates including predetermined pores,
wherein the first purified air passes through the 2-1 electrode and the 2-2 electrode.

7. The air purifier of claim 6, wherein the 2-1 electrode and the 2-2 electrode include one or more of porous nickel foam, aluminum foam, copper foam, stainless steel foam, iron foam, titanium foam, silver foam, carbon foam, and graphene foam.

8. The air purifier of claim 1, wherein the dust collector includes:
a 2-1 electrode having a plate shape extending along one plane;
a 2-2 electrode which faces the 2-1 electrode and has a needle shape including a predetermined cross-sectional area;
a plurality of dielectric particles disposed between the 2-1 electrode and the 2-2 electrode; and
a second power supply source which applies a predetermined voltage to the 2-1 electrode and the 2-2 electrode.

9. The air purifier of claim 8, wherein the plurality of dielectric particles includes at least one of a metal oxide, metal nitride, or polymer including at least one of silicon oxide, boron oxide, aluminum oxide, manganese oxide, titanium oxide, barium oxide, copper oxide, magnesium oxide, zinc oxide, zirconium oxide, yttrium oxide, calcium oxide, nickel oxide, iron oxide, polytetrafluoroethylene, and rubber.

10. The air purifier of claim 1, wherein the dust collector includes:
a 2-1 electrode having a rod shape mainly extending in a direction;
a 2-2 electrode which faces the 2-1 electrode and having a plate shape extending along a plane; and
a second power supply source which applies a predetermined voltage to the 2-1 electrode and the 2-2 electrode.

11. The air purifier of claim 10, wherein the 2-1 electrode is provided in plural, and
a plurality of 2-1 electrodes faces the 2-2 electrode and is spaced apart from each other with a predetermined gap therebetween.

12. The air purifier of claim 10, wherein the 2-2 electrode is a porous plate including predetermined pores,
wherein the first purified air passes through the 2-2 electrode.

13. The air purifier of claim 1, wherein the dust collector includes:
a 2-1 electrode having a plate shape extending along one plane;
a 2-2 electrode which faces the 2-1 electrode, has a plate shape extending along the one plane, and is grounded; and
a second power supply source which applies a predetermined voltage to the 2-1 electrode and the 2-2 electrode,
wherein the first purified air moves along between the 2-1 electrode and the 2-2 electrode.

14. The air purifier of claim 1, wherein the dust collector includes:
a 2-1 electrode having a plate shape extending along one plane;
a 2-2 electrode which faces the 2-1 electrode and has a plate shape extending along the one plane;
a second power supply source which applies a predetermined voltage to the 2-1 electrode and the 2-2 electrode; and
a dust collecting plate disposed at a rear end of the 2-1 electrode and the 2-2 electrode along a movement direction of the first purified air, wherein the first purified air moves between the 2-1 electrode and the 2-2 electrode.

15. The air purifier of claim 14, wherein the dust collecting plate is a porous plate including predetermined pores,
wherein the first purified air passes through the dust collecting plate.

16. The air purifier of claim 1, wherein the dust collector includes:
a 2-1 electrode having a rod shape mainly extending in a direction;
a 2-2 electrode which has a cylindrical shape mainly extending in the direction and is grounded, and in which the 2-1 electrode is arranged; and
a second power supply source which applies a predetermined voltage to the 2-1 electrode and the 2-2 electrode,
wherein the first purified air moves along between the 2-1 electrode and the 2-2 electrode.

17. The air purifier of claim 1, wherein the dust collector includes:
a 2-1 electrode having a rod shape mainly extending in a direction;
a 2-2 electrode which has a cylindrical shape mainly extending in the direction and in which the 2-1 electrode is arranged;
a second power supply source which applies a predetermined voltage to the 2-1 electrode and the 2-2 electrode; and
a dust collecting plate disposed at a rear end of the 2-1 electrode and the 2-2 electrode along a movement direction of the first purified air, wherein the first purified air moves between the 2-1 electrode and the 2-2 electrode.

18. The air purifier of claim 17, wherein the dust collecting plate is a porous plate including predetermined pores,
wherein the first purified air passes through the dust collecting plate.

19. An air purifier for purifying contaminated air by removing contaminants, the air purifier comprising:
an air inlet through which the contaminated air is introduced;
a plasma reaction unit connected in fluid communication with the air inlet and including a predetermined discharge region generating discharge plasma;
a gas-liquid mixing unit connected in fluid communication with the plasma reaction unit, and including:
a gas-liquid mixing unit housing;
a droplet ejection device disposed in the gas-liquid mixing unit housing and including one or more ejection nozzles ejecting fine droplets; and
a fluid mixing device which mixes the fine droplets and first purified air transferred from the plasma reaction unit;
a gas-liquid contact unit connected in fluid communication with the gas-liquid mixing unit, forming a micro-channel through which a gas-liquid mixed fluid transferred from the gas-liquid mixing unit passes, and including an impactor which collects droplets included in the gas-liquid mixed fluid; and
a dust collector which is connected in fluid communication with the gas-liquid contact unit and collects and removes the contaminants from fourth purified air discharged from the gas-liquid contact unit.

20. The air purifier of claim 19, wherein the impactor includes an inclined surface having a predetermined inclination angle with respect to a direction of gravity.
